(19) United States
(12) Patent Application Publication
(10) Pub. No.: US 2015/0000788 A1
(43) Pub. Date: Jan. 1, 2015

(54) Vented Needle

(71) Applicant: Valeritas, Inc., Bridgewater, NJ (US)

(72) Inventors: Devin V. McAllister, Shrewsbury, MA (US); Daniel W. Connors, Shrewsbury, MA (US)

(73) Assignee: Valeritas, Inc., Bridgewater, NJ (US)

(21) Appl. No.: 14/363,981

(22) PCT Filed: Dec. 12, 2012
(86) PCT No.: PCT/US12/69054

§ 371 Date: Jun. 9, 2014

Related U.S. Application Data
(60) Provisional application No. 61/569,642, filed on Dec. 12, 2011.

(51) Int. Cl. A61J 1/20

(52) U.S. Cl. CPC A61J 1/2096; A61J 2001/2075; A61J 2001/201
USPC 141/329

(57) ABSTRACT

A vented needle comprises a distal end configured to pierce a seal of a first container having a top and a bottom surface and a seal of a second container having a top and a bottom surface. An interior lumen is configured to fluidly couple the first container and a fluid transfer device and the second container and the fluid transfer device. A middle portion is configured to engage the seals of the first container and the second container and having one or more axially extending vents. At least one of the one or more vents is configured to extend axially past the top and bottom surfaces of the seal of the first container and configured to fluidly couple the first container and ambient air outside the first container. None of the one or more vents are configured to extend axially past top and bottom surfaces of the seal of the second container.

### CROSS-REFERENCE TO RELATED APPLICATIONS

This application claims the benefit of U.S. Provisional Patent Application No. 61/569,642 filed Dec. 12, 2011 entitled “Vented Needle”, incorporated by reference herein in its entirety.

### BACKGROUND OF THE INVENTION

The present invention generally relates to vented needles and, in at least one embodiment, to a vented needle for transferring fluid between two otherwise sealed containers.

A wide range of injectable drug delivery devices are known in which a fluid medicament, such as insulin, is stored in an expandable-contractible reservoir. In such devices, the fluid is delivered to the patient from the reservoir by forcing the reservoir to contract.

Such devices can be filled by the manufacturer of the fluid delivery device or such devices can be filled by a pharmacist, a physician or a patient prior to use. In order to transfer the fluid from one sealed container, such as a vial, to another sealed container, such as a fluid delivery cartridge, a fluid transfer device, such as a syringe, is typically used. Fluid delivery cartridges are typically in a collapsed state prior to use such that inserting the fluid expands the volume of the cartridge as the fluid is inserted. However, in fluid delivery device cartridges that are at least partially pre-expanded, the air within the cartridge must be vented out as the fluid is inserted in order to relieve the positive pressure. Adding a vent to the fluid delivery device cartridge or fluid transfer device may be expensive and known vents for fluid transfer devices may allow contaminants to enter the vial.

It would be desirable to provide the following vented needles for cheaply and effectively transfer fluid between two otherwise sealed containers.

### BRIEF SUMMARY OF THE INVENTION

In one embodiment there is a needle comprising: a distal end configured to pierce a seal of a first container having a top and a bottom surface and a seal of a second container having a top and a bottom surface; an interior lumen configured to fluidly couple the first container and a fluid transfer device and the second container and the fluid transfer device; and a middle portion configured to engage the seals of the first container and the second container and having one or more axially extending vents, at least one of the one or more vents being configured to extend axially past the top and bottom surfaces of the seal of the first container and configured to fluidly couple the first container and ambient air outside the first container, none of the one or more vents being configured to extend axially past top and bottom surfaces of the seal of the second container.

In one embodiment, the one or more vents are formed by a coating on an outer surface of the needle. In one embodiment, the coating forms one or more grooves. In one embodiment, the coating is comprised of an air permeable material. In one embodiment, the one or more vents include one or more grooves projecting radially inwardly from an outer surface of the needle.

### BRIEF DESCRIPTION OF THE SEVERAL VIEWS OF THE DRAWINGS

The following detailed description of embodiments of the vented needle will be better understood when read in conjunction with the appended drawings of exemplary embodiments. It should be understood, however, that the invention is not limited to the precise arrangements and instrumentalities shown.

In the drawings:

FIG. 1 is an a perspective view of a vented needle in accordance with an exemplary embodiment of the present invention;

FIG. 2 is a cross sectional view of the vented needle of FIG. 1 taken along line 2-2;

FIG. 3 is a cross sectional view of a vented needle in accordance with another exemplary embodiment of the present invention;

FIG. 4 is a cross sectional view of a vented needle in accordance with another exemplary embodiment of the present invention;

FIG. 5 is a partial cross sectional view of the vented needle of FIG. 1 filling a fluid delivery device cartridge;

FIG. 5A is a partial cross sectional view of the vented needle of FIG. 5 shown within section 5A;

FIG. 6 is a partial cross sectional view of the vented needle of FIG. 1 withdrawing fluid from a vial; and

FIG. 6A is a partial cross sectional view of the vented needle of FIG. 6 shown within section 6A.

### DETAILED DESCRIPTION OF THE INVENTION

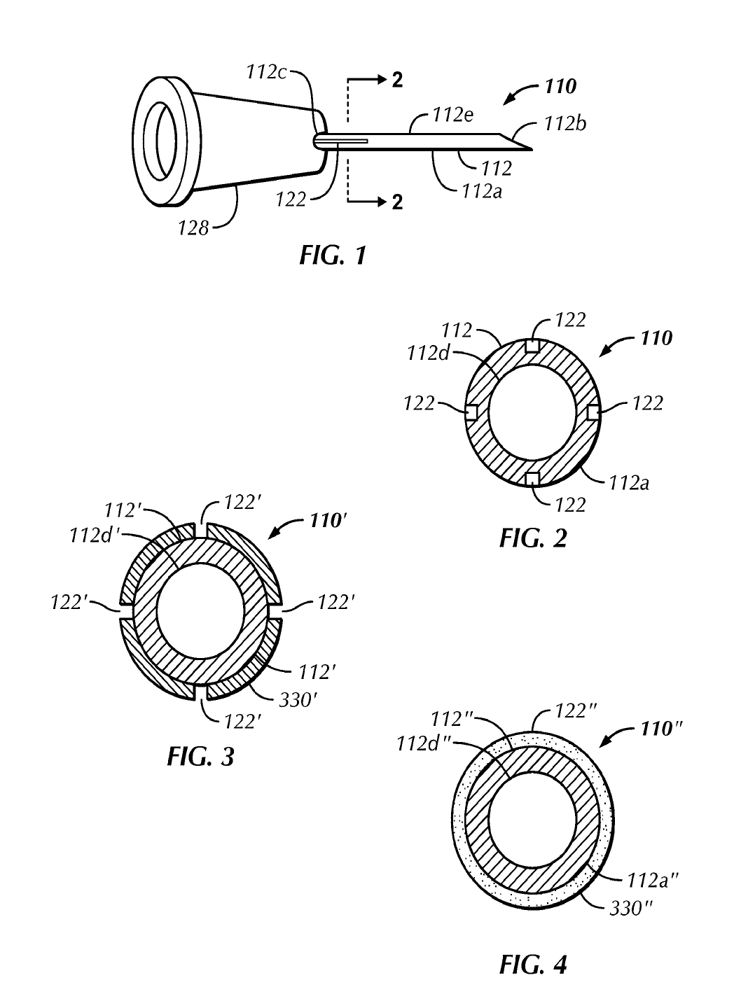

Referring to the drawings in detail, wherein like reference numerals indicate like elements throughout, there is shown in FIGS. 1-2 and 5-6A a vented needle, generally designated 110, in accordance with a first exemplary embodiment of the present invention. In some embodiments, the vented needle 110 eliminates the seal between an outer surface 112a of a needle 112 and a first septum 514 of a first container 518 such that air within the first container 518 is displaced or vented out of the first container 518 as the fluid is transferred into the first container 518. In further embodiments, the vented needle 110 eliminates the seal between the outer surface 112a of the needle 112 and the first septum 514 of the first container (e.g. a fluid delivery device cartridge) while retaining the seal between the outer surface 112a of the needle 112 and a second septum 616 of a second container 620 (e.g. a vial).

Referring to FIGS. 1 and 2, in one embodiment, the vented needle 110 includes a needle 112 having a distal end 112b. The distal end 112b of the needle 112 may include a beveled tip configured to pierce the first and second septums 514, 614. The proximal end 112c of the needle 112 may be coupled with a fluid transfer device 524 for transferring fluid through an interior lumen 112d of the needle 112. In one embodiment, the fluid transfer device 524 is a conventional syringe having a plunger 526. In one embodiment, the needle 112 is attached to a hub 128. In such an embodiment, the hub 128 may be secured to fluid transfer device 524. In another embodiment, the needle 112 may be directly attached to the fluid transfer device 524 (e.g. a staked needle).

In one embodiment, the needle 112 is a needle suitable for use with insulin syringes. In one embodiment, the needle 112 is a 30 gauge needle. In one embodiment, the needle 112 is a 26 gauge needle. In one embodiment, the needle 112 is a 27 gauge needle. In one embodiment, the needle 112 is a 28 gauge needle. In one embodiment, the needle 112 is a 29 gauge needle. In one embodiment, the needle 112 is a 30 gauge needle. In one embodiment, the needle 112 is a 31 gauge needle. In one embodiment, the needle 112 is a 32 gauge needle. In one embodiment, the needle 112 is any size and shaped needle configured to pierce a septum.

In one embodiment, the vented needle 110 includes one or more vents 122. In one embodiment, the vents 122 project radially inwardly on the surface 112a of the needle 122 and extend partially along the axial length. In one embodiment, the vents 122 begin on a middle section 112e of the needle 112 and extend toward the proximal end 112c of the needle 112 or vice versa. In one embodiment, the vents 122 generally extend in the axial direction. In other embodiments, the vents 122 are curved or spiraled around the needle 112. In one embodiment, the vents 122 are spaced equally around the circumference of the needle 112. In one embodiment, the vented needle 110 includes four vents 122 spaced equally around the circumference of the needle 112. In another embodiment, the vented needle 110 includes three vents 122 spaced equally around the circumference of the needle 112. In another embodiment, the vented needle 110 includes two diametrically opposed vents 122. In other embodiments, the vented needle 110 includes any number of vents 122 in any spaced configuration that provides suitable air flow between the outer surface 112a of the needle 112 and the first septum 514.

In one embodiment, other than reducing the pressure within the first container 518 by bypassing the first septum 514, the vents 122 do not interfere with the fluid flowing through the interior lumen 112d. In one embodiment, the vents 122 are rectangular shaped grooves. In other embodiments, the vents 122 may have any suitable shape for creating an air passageway between the outer surface 112a of the needle 112 and the first septum 514 such as triangular or semicircular (not shown). In one embodiment, the size and shape of the vent 122 is configured to prevent the first septum 514 from filling in the vent 122 during use. In one embodiment, the vent 122 is sufficiently narrow to prevent the vent 112 from being substantially filled in by the septum 514. In one embodiment, the vent 122 has a circumference width that is larger toward the interior lumen 112d.

In one embodiment, the vents 122 are sized and configured to control the rate at which air is vented from the first container 518. In one embodiment, the vents 122 are sized and configured to only allow a controlled fluid delivery rate through the needle 112 by vented a restricted amount of air past the first septum 514 to minimize the amount that air is mixed in with the transferred fluid. In such embodiments, it may be desirable to keep turbulent fluid flow into the first container 518 at a minimum since at least some of the air bubbles from a turbulent fill may not be vented from the first container 518. In other embodiments, the size and configuration of the vents 122 may be configured to maximize the speed at which air is vented from the first container 518.

In one embodiment, the vents 122 are formed by milling into the outer surface 112a of the needle 112. In other embodiments, the vents 122 are formed by molding of the needle 112 or etching onto the surface of the needle 112 depending on the type of material of the needle 112. In one embodiment, the vents 122 are laser cut. In one embodiment, the outer surface 112a of the needle 112 is roughened to prevent a seal between the outer surface 112a in the roughened area and the first septum 514. Such an embodiment may be preferred for smaller gauge needles 112 where cutting into the outer surface 112a is difficult due to the size of the needle 112.

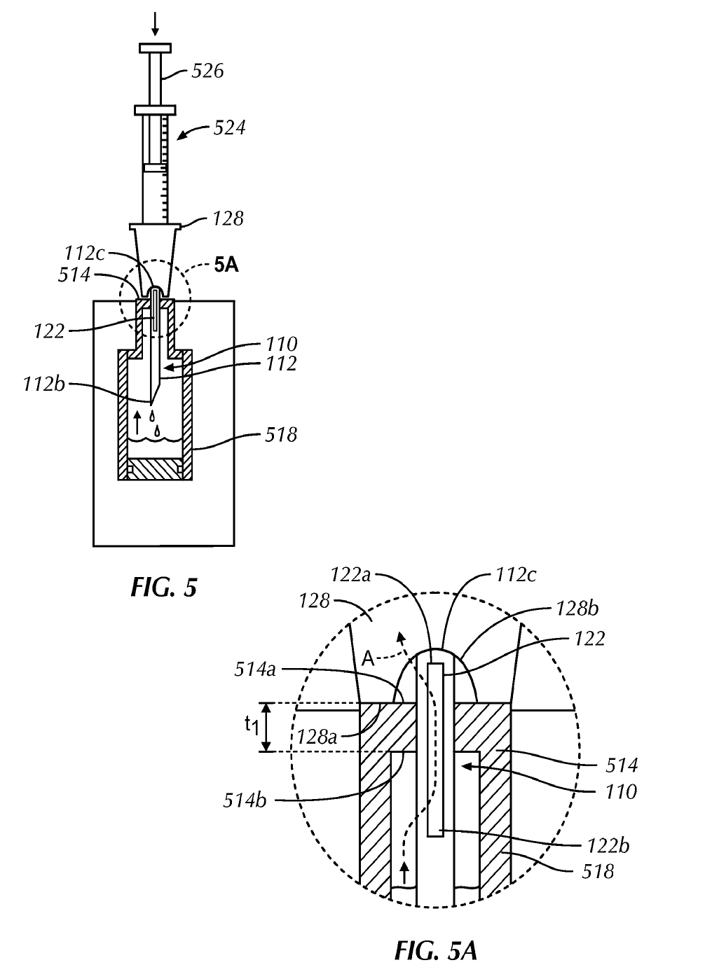

Referring to FIG. 5A, at least one vent 122 includes a proximal end 122a and a distal end 122b. In one embodiment, the proximal end 122a of the vent 122 extends further outwardly from a top surface 514a of the first septum 514 and the distal end 122a of the vent 122 extends further downwardly from a bottom surface 514b of the first septum 514 such that the first container 518 is in fluid communication with the outside of the first container 518 during use of the vented needle 110 with the first container 518. In such an embodiment, as fluid in injected into the first container 518 (e.g. by depressing the plunger 526, FIG. 5), through the interior lumen 112d of the needle 112, the fluid rises displacing air within the first container 518 up into the vents 122 and out of the container (See e.g., air passageway A). The vents 122 cause gaps between the outer surface 112a of the needle 112 and the first septum 514 that allow the air to escape from the otherwise sealed first container 518. In one embodiment, the proximal end 128a of the hub 128 includes one or more apertures 128b. The apertures 128b allow the vents 122 to be in fluid communication with the ambient air. The proximal end 128a of the hub 128 is configured to engage the first and second septums 514, 616 and position the vents 122 with respect to the first and second septums 514, 616 during use. In one embodiment, an aperture 128b is provided proximate each vent 122. In another embodiment, a single aperture is in fluid communication with all of the vents 122.

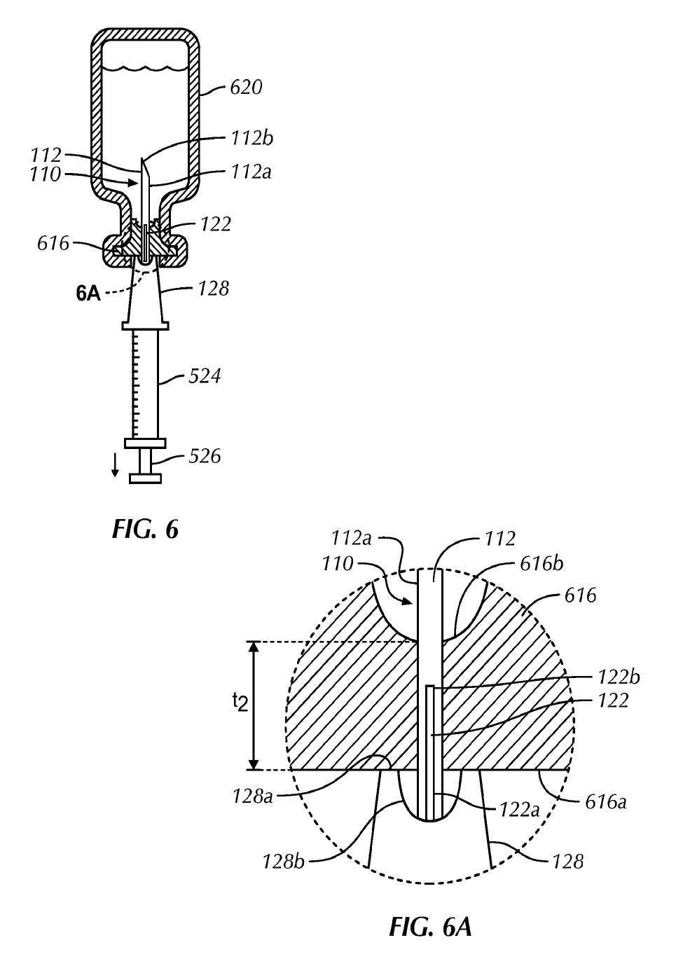

Referring to FIG. 6A, in one embodiment, the distal end 122b of the vent 122 does not extend further than a bottom surface 616b of the second septum 616 because the second septum 616 has a greater thickness t₂ than the thickness t₁ of the first septum 514. In such an embodiment, though the proximal end 122a of the vent 122 extends outwardly further than a top surface 616a of the second septum 616 the seal between the outer surface 112a of the needle 112 and the second septum 616 is retained within the area between the bottom surface 616b of the second septum 616 and the distal end 122b of the vent 122. In one embodiment, retaining the seal with the second septum 616 allows the vented needle 110 to be used with the second container 620, such as a vial, no differently than a conventional needle while allowing the vented needle 110 to vent the air from the second container 620 during filling of the second container 620.

Referring to FIG. 3, there is shown a second exemplary embodiment of the vented needle, generally designated 110′. The vented needle 110′ is similar to the first exemplary embodiment of the vented needle 110 except that the vents 122′ are formed by a coating 330′ or sleeve on the outer surface 112a′ of the needle 112′. Such embodiments, like the roughened surface embodiment discussed above, may be preferred for smaller gauge needles where cutting into the outer surface 112a′ of the needle 112′ may be difficult due to the size of the needle 112′. In one embodiment, the coating 330′ extends axially along the outer surface 112a′ of the needle 112′ approximately the length of the vents 110′. In other embodiments, the coating 330′ substantially covers the entire needle 112′. In one embodiment, the coating 330′ is applied to the needle 112′ and the vents 122′ are formed into the coating 330′. In one embodiment, the coating 330′ is photo-definable. In one embodiment, the coating 330′ is laser cut to form the vents 122′. In one embodiment, the coating 330′ is plated onto the needle 112′. In one embodiment, the coating 330′ is grown onto the needle 112′. In other embodiments, the coating 330′ is applied to form the vents 122′ without removal of coating material. In one embodiment, the coating 330′ forms radially outwardly extending projections.

Referring to FIG. 4, there is shown a third exemplary embodiment of the vented needle, generally designated 110″. The vented needle 110″ is similar to the second exemplary embodiment of the vented needle 110′ except that the coating 330″ is sufficiently porous (i.e. air permeable) to create a vent 330″.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined. Unless specifically set forth herein, the terms “a”, “an” and “the” are not limited to one element but instead should be read as meaning “at least one”.

I/we claim:

1. A needle comprising:
a distal end configured to pierce a seal of a first container having a top and a bottom surface and a seal of a second container having a top and a bottom surface;
an interior lumen configured to fluidly couple the first container and a fluid transfer device and the second container and the fluid transfer device; and
a middle portion configured to engage the seals of the first container and the second container and having one or more axially extending vents, at least one of the one or more vents being configured to extend axially past the top and bottom surfaces of the seal of the first container and configured to fluidly couple the first container and ambient air outside the first container, none of the one or more vents being configured to extend axially past top and bottom surfaces of the seal of the second container.

2. The needle of claim 1, wherein the one or more vents are formed by a coating on an outer surface of the needle.

3. The needle of claim 2, wherein the coating forms one or more grooves.

4. The needle of claim 2, wherein the coating is comprised of an air permeable material.

5. The needle of claim 1, wherein the one or more vents include one or more grooves projecting radially inwardly from an outer surface of the needle.
